(19) United States
(12) Patent Application Publication
(10) Pub. No.: US 2014/0318322 A1
(43) Pub. Date: Oct. 30, 2014

(54) JAR AND BOTTLE OPENER

(71) Applicant: Thomas Franklin Thrasher, Rector, AR (US)

(72) Inventor: Thomas Franklin Thrasher, Rector, AR (US)

(21) Appl. No.: 13/871,398

(22) Filed: Apr. 26, 2013

(51) Int. Cl. B67B 7/18; B67B 7/14

(52) U.S. Cl. CPC B67B 7/18; B67B 7/14
USPC 81/3.25; 81/3.4; 81/3.44

(57) ABSTRACT

A jar top opener that includes: a first brace, where the first brace includes a plurality of serrated blades along a first side of the first brace; a connecting end of the first brace; a distal end of the first brace; a second brace, where the second brace includes an outside surface and an inside surface; a connecting end of the second brace, where connecting end of the second brace connects to the connecting end of the first brace, where the first brace and the second brace create a v-shape with an opening between the inside of the second brace and the first side of the first brace; and a distal end of the second brace.

### BACKGROUND OF THE INVENTION

1. Field of Invention

The present invention is a jar and bottle opener that is utilized to easily remove the top off a jar or bottle.

2. Description of Related Art

Many individuals have difficulty in opening jars due to the tight seals that are placed upon the screw-on tops. The tight seals are utilized to ensure that the contents of the jar remain fresh and further to provide an indication that the jar has not been tampered with prior to use by the end user. Some devices have been developed to address the removal of jar tops. The container opener disclosed in U.S. Pat. No. 3,120,771 describes a tool for removing the closures of containers and suggests use for carbonated beverages that may have crimped on or crown caps. Another example of a jar-opening appliance is disclosed in U.S. Pat. No. 7,841,093 that discloses an under-cabinet household opening appliance that had a jar opener mounted on the bottom wall of the can opening housing. Other similar tools are also disclosed in the prior art. Further development of jar opening devices would however enhance the ability for users to remove jar tops and in some instances bottle tops that are tightly twisted in place.

### SUMMARY OF THE INVENTION

The present invention relates to a jar top opener comprising: a first brace, where the first brace includes a plurality of serrated blades along a first side of the first brace; a connecting end of the first brace; a distal end of the first brace; a second brace, where the second brace includes an outside surface and an inside surface; a connecting end of the second brace, where connecting end of the second brace connects to the connecting end of the first brace, where the first brace and the second brace create a v-shape with an opening between the inside of the second brace and the first side of the first brace; and a distal end of the second brace. The opening may be adjustable through radial movement of the second brace.

### BRIEF DESCRIPTION OF DRAWINGS

FIG. 1 depicts a jar opener device in accordance with the present invention.

### DETAILED DESCRIPTION

The present invention relates to a jar opener that is mounted on the underside of a kitchen wall cabinet. The jar opener in accordance with the present invention includes a first brace where the first brace has a series of serrated blades on a first side of the brace. The first brace connects to a second brace that includes an outside surface and an inside surface. The connection with the first brace and the second brace creates a V-shape where the inside surface of the second brace and the serrated blades of the first brace create an opening for the insertion of a jar cap. During use, the first brace is mounted on the underside of the cabinet with the serrated teeth along the inside surface of the first brace. This appliance grips the top of the jar and therefore ensures a non-slip attachment thereto. The jar moves into the opening, which may be varied by the radial movement of the second brace.

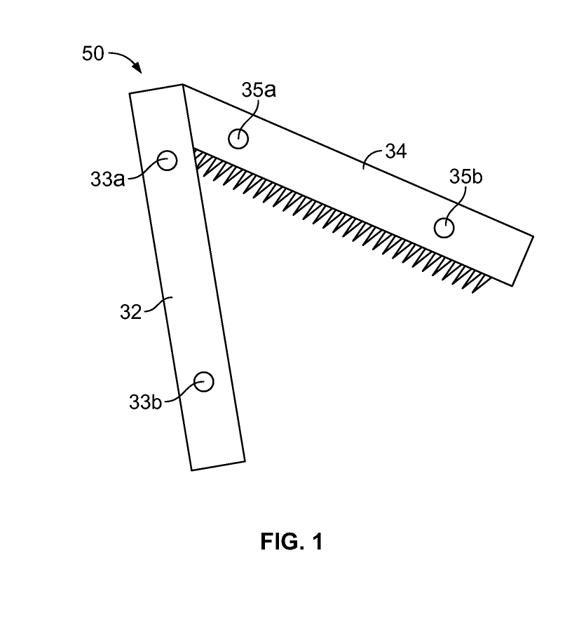

In reference to FIG. 1, a jar opener 50 in accordance with the present invention is depicted. The jar top opener 50 includes a first brace 34 and a second brace 32. Both the first brace 34 and second brace 32 have a connecting end respectively that joins the two braces to create a V-shape. The V-shape of the jar top opener 50 includes an opening for the insertion of a jar top. Along the inside surface of the brace 34 are a series of serrated blades that grip the jar top when placed within the V-shaped opening. This configuration allows the user to firmly twist the jar in order for the initial movement of the jar top and releasing the seal on the top of the jar.

The opening between the second brace 32 and first brace 34 may be varied by radially moving the second brace 32 to either widen the V-shaped opening or to narrow the V-shaped opening so that the jar opening device 50 may accommodate different-sized jars.

The first brace 34 and second brace 32 include openings, in particular openings 33a, 33b along the top side of the second brace 32; and openings 35a, 35b along the top surface of the first brace 34. These openings provided in each brace allow for the insertion of screws or bolts to mount the device on the underside of a cabinet. Once mounted the jar may be inserted within the opening for use by the user. The instant invention has been shown and described in what it considers to be the most practical and preferred embodiments. It is recognized, however, that departures may be made there from within the scope of the invention and that obvious modifications will occur to a person skilled in the art.

What is claimed is:

1. A jar top opener comprising:
a. a first brace, where the first brace includes a plurality of serrated blades along a first side of the first brace;
b. a connecting end of the first brace;
c. a distal end of the first brace;
d. a second brace, where the second brace includes an outside surface and an inside surface;
e. a connecting end of the second brace, where connecting end of the second brace connects to the connecting end of the first brace, where the first brace and the second brace create a v-shape with an opening between the inside of the second brace and the first side of the first brace; and
f. a distal end of the second brace.

2. The jar opener according to claim 1, where the opening is adjustable through radial movement of the second brace.

3. The jar opener according to claim 1, where the first brace and second brace include holes along a top side of the first brace and a top side of the second brace.

4. The jar opener according to claim 3, where the holes receive bolts there through to enable mounting of the jar opener onto an underside of a cabinet.

5. The jar opener according to claim 4 where the bolts are screws.

6. The jar opener according to claim 1, where the opening receives a top of a jar and said top is firmly gripped between the first brace and second brace.
